(19) United States
(12) Patent Application Publication
(10) Pub. No.: US 2015/0098561 A1
(43) Pub. Date: Apr. 9, 2015

(54) SYSTEM AND METHOD FOR REAL-TIME MONITORING OF A CONTACT CENTER USING A MOBILE COMPUTER

(71) Applicant: NICE-SYSTEMS LTD., Ra'anana (IL)

(72) Inventors: Yohay ETISON, Tel Aviv (IL); Micha Catran, Beit Itzhak (IL); Roie Mandler, Kfar-Saba (IL); Maxim Nosko, Tel-Aviv (IL); Ran Liron, Petach Tikva (IL)

(73) Assignee: NICE-SYSTEMS LTD., Ra'anana (IL)

(21) Appl. No.: 14/086,008

(22) Filed: Nov. 21, 2013

Related U.S. Application Data
(60) Provisional application No. 61/888,224, filed on Oct. 8, 2013.

(51) Int. Cl. H04M 3/51; G06F 3/0488; G06F 3/0481; G06Q 10/06

(52) U.S. Cl. CPC H04M 3/5175; G06Q 10/06398; G06F 3/0488; G06F 3/04817
USPC 379/265.06

(57) ABSTRACT

A system and method is provided for monitoring a contact center in real-time. An overview page may be displayed providing information associated with a plurality of agents in a contact center including real-time status information indicating that one or more of the plurality of agents are currently involved in customer interactions and indicating progress of the interactions. An interaction page may be displayed for a selected one of the customer interactions providing computer-generated information summarizing the customer interaction in real-time. A user may be connected to the customer or agent to intervene in the selected interaction.

### CROSS-REFERENCE TO RELATED APPLICATIONS

This application is a Utility application of U.S. Provisional Patent Application No. 61/888,224, filed Oct. 8, 2013 entitled “SYSTEM AND METHOD FOR REAL-TIME MONITORING OF A CONTACT CENTER USING A MOBILE COMPUTER” which is incorporated in its entirety herein by reference.

### FIELD OF THE INVENTION

Embodiments of the invention relate to systems and methods for monitoring customer-agent interactions at contact centers. In particular, embodiments of the invention provide managerial tools, such as, user interfaces for managers to oversee and join customer-agent interactions. Some embodiments of the invention relate to mobile platforms on tablet or mobile devices to allow managers to monitor the call center from any location, for example, while circulating a contact center floor.

### BACKGROUND OF THE INVENTION

Modern automated contact centers typically incorporate data from a large number of separate workflow systems, databases, telephony systems, and monitoring tools. However, no current system collates all the relevant information from those disparate systems into a single master workflow system designed specifically for contact center managers.

At the same time, current contact centers have become too large and geographically spread-out for managers to rely on in-person/on-the-floor monitoring techniques. These techniques do not provide managers with instant access to relevant computerized information that automatically transcribes and analyzes the progress and content of each interaction. Contact centers are also too dynamic to be directed “after-the-fact” in which the manager retroactively reads and manually collates information from disparate systems.

### SUMMARY OF EMBODIMENTS OF THE INVENTION

In accordance with an embodiment of the invention, a system and method is provided for a single, easy-to-use user interface that consolidates historical and real-time data, gives managers real-time, top-level summaries of computer-transcribed interactions currently under discussion, flags key topics, alerts managers of anomalies, problems and trends, and provides managers with a one-touch method to obtain details of any interaction and to intervene in a customer-agent interaction by listening in on the interaction, joining the interaction, or communicating with the agent in a separate concurrent interaction.

In accordance with an embodiment of the invention, a system and method provides a mobile computing environment, for example, using a tablet or mobile device, that provides information to mobile managers. The mobile computing environment provides contact center information to mobile managers, for example, who are on the contact center floor, in meetings, in coaching or training sessions or on their way to/from work, so that they may manage their agents effectively and make decisions in real time.

In accordance with an embodiment of the invention, a system and method is provided for monitoring a contact center in real-time. An overview page may be displayed providing information associated with a plurality of agents in a contact center including real-time status information indicating that one or more of the plurality of agents are currently involved in customer interactions and indicating progress of the interactions. An interaction page may be displayed for a selected one of the customer interactions providing computer-generated information summarizing the customer interaction in real-time. A user may be connected to the customer or agent to intervene in the selected interaction.

In accordance with an embodiment of the invention, a system and method is provided for monitoring a contact center in real-time. A user interface may be displayed providing a first overview page showing a plurality of graphical icons including information associated with a plurality of respective contact center agents. Each graphical icon may indicate a current task being executed by the associated agent and a progress of the task in real-time. A second page for one of the plurality of contact center agents associated with a graphical icon on the first page may be displayed providing statistics indicating the performance of the associated agent in successfully completing the current task.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system for monitoring a contact center in real-time in accordance with an embodiment of the invention;

FIG. 2 schematically illustrates a method for monitoring a contact center integrating information from multiple systems in accordance with an embodiment of the invention;

FIG. 3 schematically illustrates a method for monitoring a contact center in real-time in accordance with an embodiment of the invention;

FIG. 4 schematically illustrates a user interface displaying performance statistics for agents in a contact center in accordance with an embodiment of the invention;

FIG. 5A schematically illustrates a user interface displaying an overview page for monitoring a contact center in accordance with an embodiment of the invention;

FIGS. 5B-5E provide keys for the icons and terminology used in FIG. 5A in accordance with an embodiment of the invention;

FIG. 6 schematically illustrates an alert to be displayed on the user interface and a key of icon alert categories that may trigger the alert display in accordance with an embodiment of the invention;

FIG. 7A schematically illustrates a user interface displaying an interaction page for monitoring an interaction in accordance with an embodiment of the invention;

FIG. 7B provides a key defining icons and terminology used in FIG. 7A in accordance with an embodiment of the invention;

FIG. 8 schematically illustrates a user interface providing a chat screen for a user to communicate with one of the agents in a contact center in accordance with an embodiment of the invention;

FIG. 9A schematically illustrates a user interface for monitoring the performance of agents in a list view in accordance with an embodiment of the invention;

FIG. 9B shows the information displayed in the interaction page of FIG. 9A in accordance with an embodiment of the invention;

FIG. 9C schematically illustrates a user interface providing a current interaction details sub-page for a selected interaction or agent in accordance with an embodiment of the invention;

FIG. 10A schematically illustrates a graph view showing popular topics of customer interactions, for example, referred to as “hot topics,” in accordance with an embodiment of the invention;

FIG. 10B schematically illustrates a user interface providing a detailed view of the information for one of the plurality of topics represented in FIG. 10A in accordance with an embodiment of the invention;

FIG. 11 schematically illustrates a table view of the plurality of topics of FIG. 10A in accordance with an embodiment of the invention; and

FIG. 12 is a flowchart of a method for monitoring a contact center in real-time in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may provide a mobile console with a hierarchical navigation workflow structure providing a sequence of ordered pages, each subsequent page providing the user (e.g. manager) with additional details associated with an element selected from the previous page. In one example, the ordered navigation sequence may begin with an overview page (e.g. providing an overview of the status of current tasks being executed in real-time by each of a plurality of contact center agents and the progress/duration associated with each task), followed by an interaction page (e.g. providing real-time analysis information for a selected interaction/task from the overview page), followed by an agent page or a customer page (e.g. providing individual real-time and/or historical data associated with the selected agent or customer), followed by an intervention page (e.g. connecting the user to intervene with the selected agent and/or customer), and/or followed by an agent training page (e.g. to rate or provide feedback on agent performance, to schedule the agent for a training session, or to view and/or edit the agent's training schedule). Depending on the specific navigation path selected by the user and/or in other embodiments, some of the pages in the ordered sequence may be skipped, repeated, or viewed in a different order.

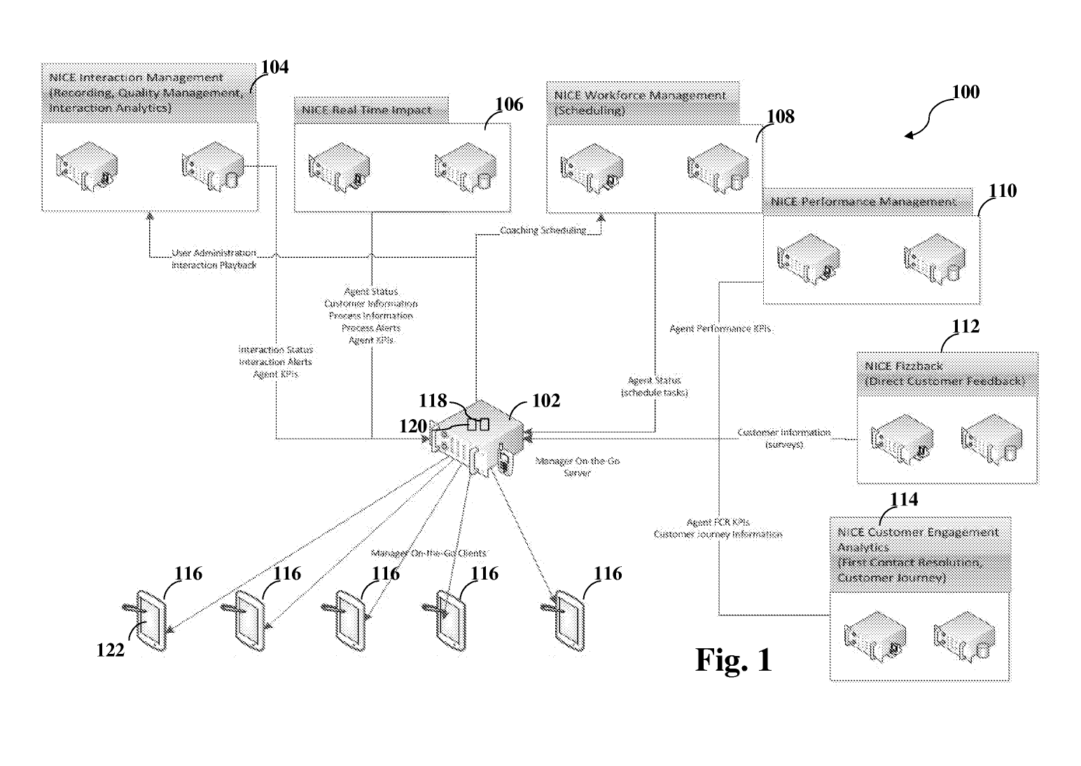

In some embodiments, a central console (e.g. server 102 of FIG. 1) may aggregate information from disparate or remote modules or systems (e.g. modules 104-114 of FIG. 1) for each of a plurality of the sequential pages. For example, an interaction management module (e.g. module 104 of FIG. 1) may provide information displayed on the overview page, such as, current task status, for example, indicating current interactions, interaction durations and/or interaction progress. An analysis module (e.g. module 106 of FIG. 1) may provide information displayed on the interaction page including, for example, agent performance statistics such as key performance indicators (KPIs), customer information, information summarizing the interaction and/or automated alerts for problem, fraud detection or high-priority interactions. A performance management module (e.g. module 110 of FIG. 1) may provide information displayed on the agent page including, for example, real-time information defining the agent's performance in the current interaction and the agent's cumulative performance score averaged over historical data associated with the agent's past interactions. A customer information module (e.g. modules 112 and/or 114 of FIG. 1) may provide information displayed on the customer page including real-time customer interaction summary information and historical customer interaction data. A workforce management module (e.g. module 108 of FIG. 1) may provide information displayed on the agent training page for scheduling/training the agent. The central console may serve information from modules to pages according to a one-to-one relationship (each module serving content to one page), a one-to-many relationship (each module serving content to multiple pages) and/or a many-to-one relationship (multiple modules serving content to one page). Each module may include separate software, separately stored executable instructions, separate hardware devices such as separate computers or servers, separate workflow processes, or a combination thereof. Other modules may be used and multiple modules may be combined into one device.

Embodiments of the invention may provide a master-console executing a master workflow that coordinates these disparate modules and associated line-of-business workflow systems for centralized contact center management. Embodiments of the invention may collate key information from each disparate module, use expert-system methods to combine the information, automatically analyze the amalgamated information, present actionable management information in a visual format specifically designed for quick decisions, and use automated alerts to flag critical issues and exceptions. Information may be extracted and coordinated from disparate systems, for example, via an application programming interface (API), a connector or other imported data file. Each of one or more fields in the user interface may be linked to input information captured, extracted or recorded by a separate system or module. By integrating telephony and chat systems into the master-console, embodiments of the invention may permit managers to play back past interactions involving an agent and intervene in current interactions, for example, using a) one-touch connection methods to connect directly with the agent via call or integrated “chat” capabilities, and b) permit the manager to “listen-in” or join the current interaction or call.

The consolidation of information from disparate workflow systems may enable managers to track many types of content center information in real-time. For example, an overview page may display a graphical icon for each agent indicating the agent's current task, the duration/progress of each interaction and/or the priority of the customer being served in each interaction. The agent tasks may indicate which agents are online, engaged in interactions, requesting assistance/intervention, and/or engaged in long interactions (having a duration exceeding a predetermined threshold of time)—e.g. consuming too much time at reduced return. Selection of an agent's icon, for example, via one-touch of a touch screen interface or a mouse-click on a computer, may trigger the interface to “drill-down” and navigate to the next sequential interaction/agent/customer page to expand the details of the selected interaction/agent/customer, respectively. The subsequent page may display the topic of the selected interaction, the performance of the selected agent, the duration of the interaction, and/or real-time and historic customer feedback and issues. Managers may select to intervene in the interaction real time, for example, by joining the agent-customer interaction e.g. via telephone or chat, by initiating a separate and concurrent interaction with only the agent (and not the customer) to guide the agent to successfully interact with the customer e.g. via telephone or chat, or by listening to/observing the current interaction or prior interactions between the customer and/or agent.

Embodiments of the invention may tackle contact center management issues in real time using mobile manager user interfaces for managers on mobile devices, such as, tablet and touch-screen devices, and/or on desktop or laptop devices. A mobile manager user interface and/or system may be referred to as a “Manager-On-the-Go.”

The mobile manager user interface may display agent performance statistics, for example, such as, key performance indicators (KPIs) for all or a subset of agents under supervision, as well as details of each agent's tasks and/or task duration/progress in real-time. Each agent's interactions with a customer may be represented by a graphical icon, such as, a “tile” or window. Within each icon, information related to an individual agent may be displayed to the manager, including, for example, how long the agent has been on the call, what type of customer the agent is dealing with and what the issues are that the agent is discussing with the customer. The tile display may flag probable fraudulent caller attacks, problem interactions or high-priority interactions, for example, alerting both the agent and the manager. If the agent requests manager or supervisor intervention, or if advanced computer-based analytics automatically determine that an intervention is required, the user interface may display an intervention icon in the agent's tile. The manager may also “drill down” or select each agent's tile to obtain additional information about the current interaction, agent or customer, for example, to view the agents' KPIs and/or call history with that customer.

Embodiments of the invention may input, for example, one or more of the following real-time contact center information:
“Big Data” management information—enables processing of data from multiple channels (e.g. telephone calls, text messaging, email, tracked Internet behavior), for example, analyzing terabytes of raw data and millions of customer records (e.g. provided by module 104 of FIG. 1).
Sophisticated rules engine and comprehensive cross-channel analytics identify contact reasoning and identify discussion topics for all calls, emails and/or chat interactions (e.g. provided by module 106 of FIG. 1).
Sequencing engine and reports isolate customer identity across channels and first call resolution failures by contact reasoning, customer attributes, agents and teams (e.g. provided by module 114 of FIG. 1).
High-visibility dashboards tailored for supervisors, analysts and executives make it possible to understand the actual cost of repeat contacts and take immediate, targeted action to improve first call resolution (e.g. provided by module 102 of FIG. 1).

Conventional call center management typically involves time-consuming, personnel-intensive methods and may only address issues after-the-fact, after the call has already ended. Embodiments of the invention may improve upon current contact center technologies by providing effective contact center management that includes: a) a physical presence of managers in the contact center by providing mobile computer monitoring tools and/or b) automated monitoring of in-process or current interactions and/or c) access to off-line interaction recordings and logs and d) workflow reports for after-the-fact course-corrections, analysis and agent re-training.

Embodiments of the invention may provide a master workflow system that includes the following systems and functionality: 1) Agent productivity systems, 2) Call tracking, 3) Telephony systems, 4) Customer relationship management (CRM) systems, 5) Call center analytics, 6) Call center automatic transcription systems, 7) Transaction authorization compliance systems, 8) Intelligent fraud detection management systems, and/or 9) Business process improvement systems.

Embodiments of the invention may provide a mobile manager user interface in a single hand-held device (e.g. mobile device 116 of FIG. 1) integrating the combined power of a plurality of these call-center systems. Combining these different systems into one mobile user interface or dashboard, embodiments of the invention may allow users to easily visualize and access the depth, breadth and power of these contact center technologies.

Embodiments of the invention may be designed to help “up-level” the personal impact of contact center managers by empowering them to do their job with greater efficiency, greater reach and less drudgery. Embodiments of the invention may make the call-center's activities more visible to executives that use the contact center as a potential strategic asset for customer retention.

Reference is made to FIG. 1, which schematically illustrates a system 100 for monitoring a contact center in real-time in accordance with an embodiment of the invention. System 100 includes a centralized server or module 102 extracting and processing contact center information from a plurality of systems or modules 104-114, collating the contact center information in a mobile manager user interface, and providing the mobile manager user interface to mobile user devices 116 to display the contact center information in real-time in a mobile environment. Users (e.g. managers) may view the contact center information while mobile, for example, while circulating a contact center floor.

Each of modules 104-114 may include one or more controller(s) or processor(s) 118 to execute logic and/or instructions to implement operations according to embodiments of the present invention and one or more memor(ies) 120 to store the logic and/or instructions, as well as input to, output from and/or intermediary results generated according to embodiments of the present invention. Processor(s) may be configured to perform methods according to embodiments of the present invention by, for example, being coupled to memory storing software or instructions which when executed cause processor to carry out embodiments of the present invention. In various embodiments, processor may be a general purpose computer processor or central processing unit executing software, digital signal processors (DSPs) or dedicated chip, or other circuitry. Processor(s) 118 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 120 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

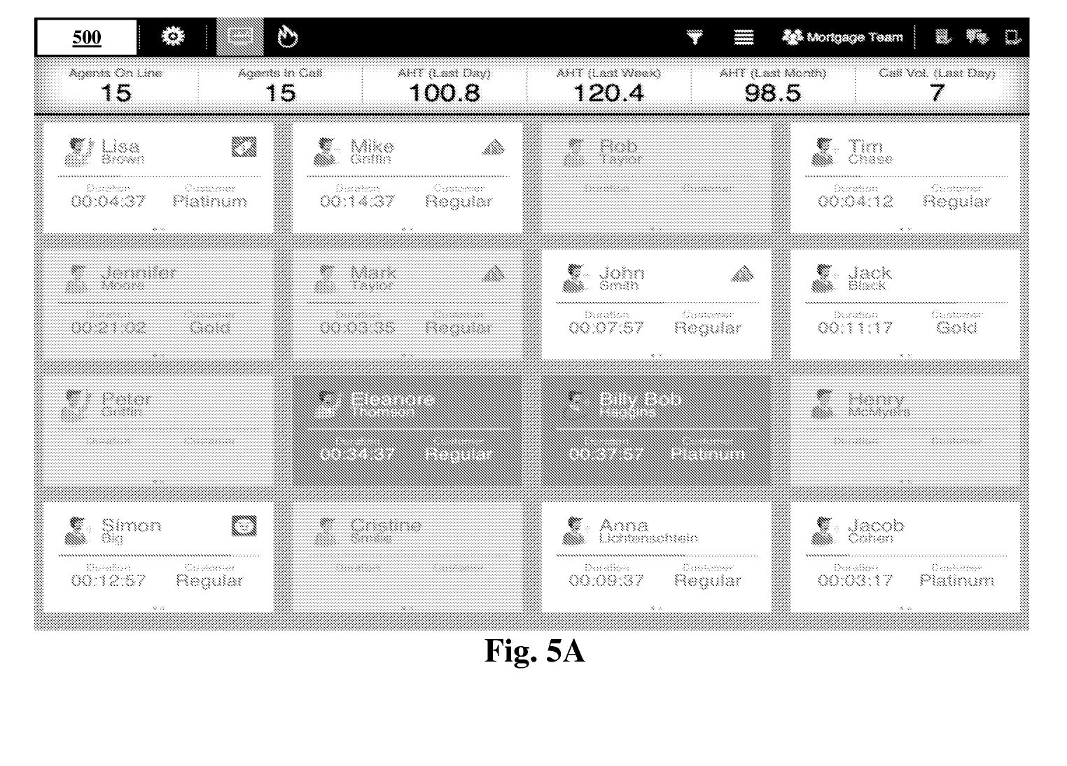

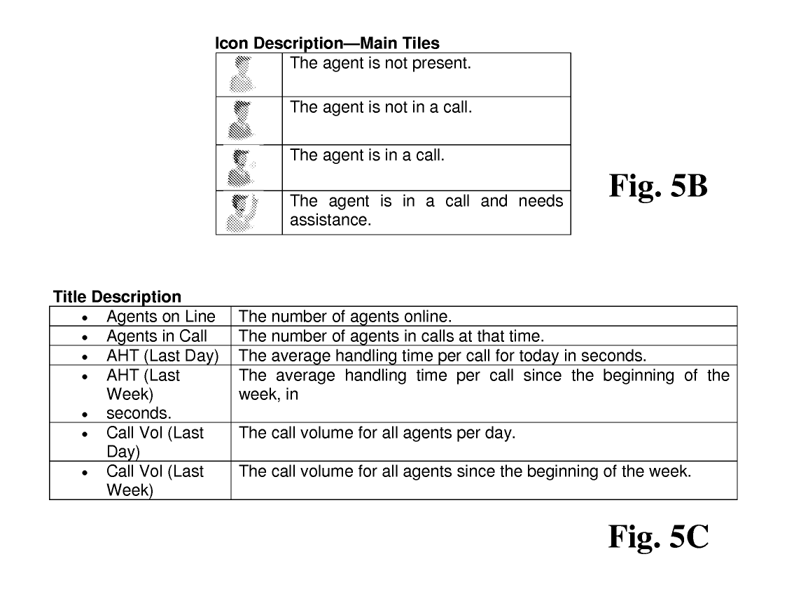

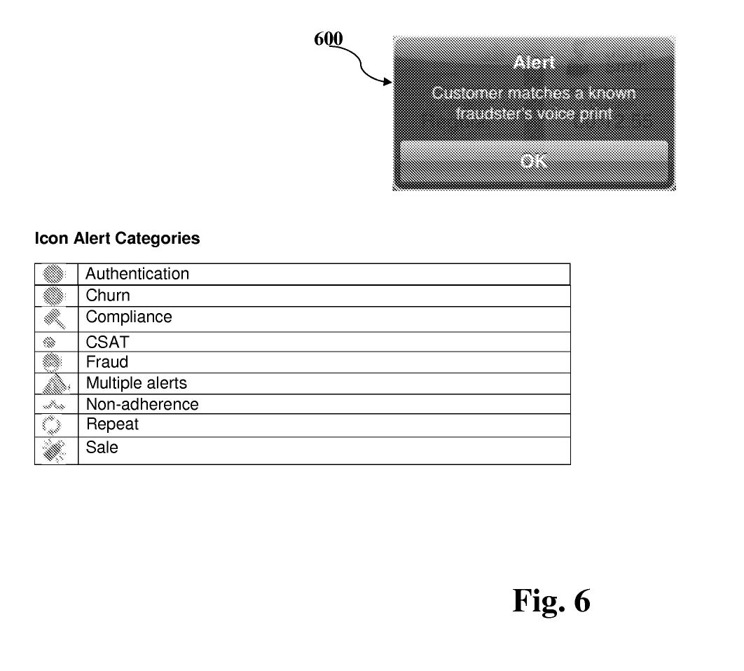

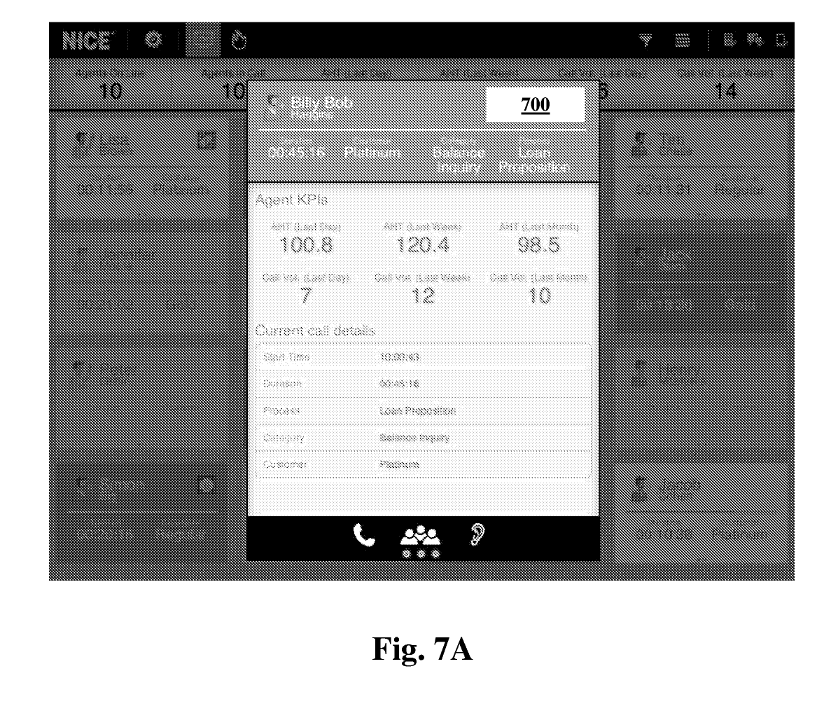

Processor(s) 118 in module 102 may generate and provide to mobile user devices 116 the mobile manager user interface. The user interface may include an overview page (e.g. shown in FIG. 5A, 9A) and an interaction page (e.g. shown in FIG. 7A, 9C). The overview page may provide information associated with a plurality of agents in a contact center that may include, for example, all agents or a sub-group thereof in a company, department, group or team, agents currently logged on-line or agents currently scheduled to work or train. The overview information may include real-time status information indicating that one or more of the plurality of agents are currently involved in customer interactions and indicating progress and/or duration of the interactions. Progress may be a ratio or relative measure of the duration of the interaction to a predetermined threshold duration e.g. considered a long call, which may be configurable. Each agent may be represented by a visual icon, such as a tile, in the overview page. A visual marker such as highlighting, color or an icon may indicate the current task of each agent including that the agent is currently on a call, the agent is on a long call, the agent needs assistance, etc. The interaction page associated with a selected one of the customer interactions may provide computer-generated information summarizing the customer interaction in real-time. Summary information may include a written or textual report, for example, summarizing the customer's problem or issue and the resolution or action provided by the agent. The report may be entered manually by an agent, transcribed from the call using a speech-to-text and/or voice-recognition engine, or extracted from screen-shots captured from the agent's workplace display. The summary report may be sent to managers in real-time (while the interaction being summarized is ongoing) or immediately after the interaction is ended or transferred to another agent.

Module 102 may provide the aforementioned information to one or more mobile user devices 116 to receive and/or locally compile or generate the mobile manager user interface. Each mobile user device 116 may include a display 122 to display the mobile manager user interface. Display 122 may be touch operated.

Module 102 may connect mobile user device 116 to the customer and/or agent devices to intervene in the interaction. Module 102 may include, or link mobile user device 116 and/or customer/agent device(s) to, a communications device providing chat, text messaging, telephone, video conferencing, or other means of communication.

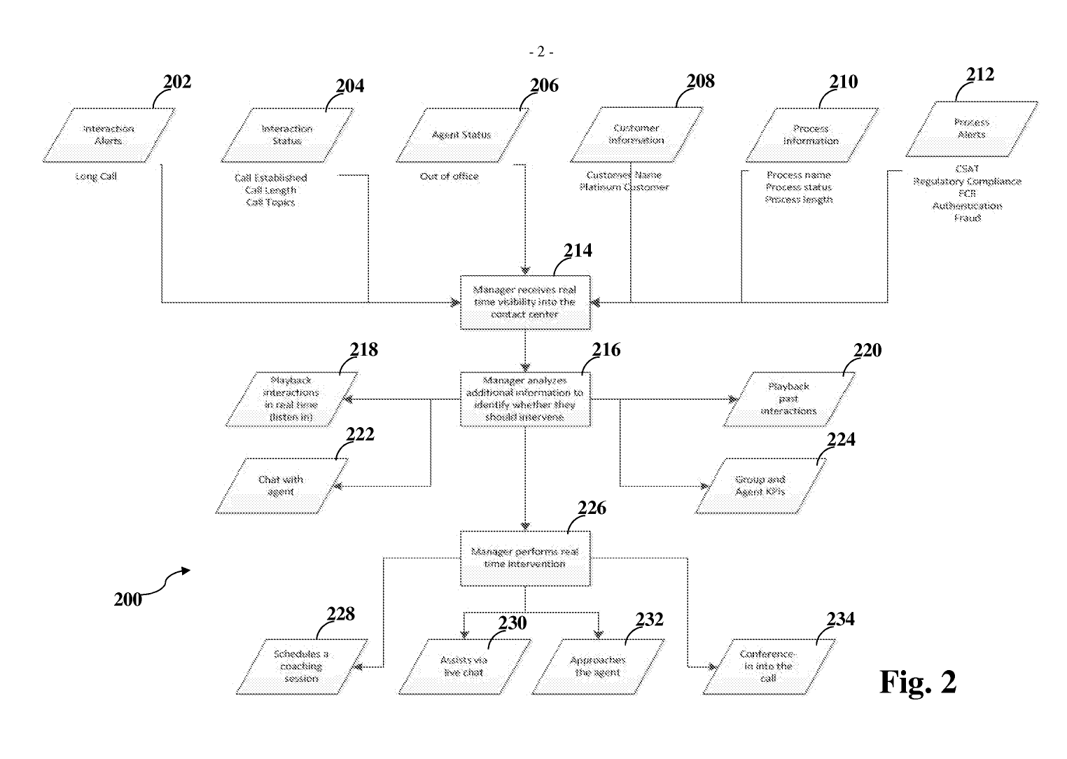

Reference is made to FIG. 2, which schematically illustrates a method for monitoring a contact center integrating information from multiple systems in accordance with an embodiment of the invention. The method of FIG. 2 may be executed by a processor, such as, processor(s) 118 in one or more of modules, such as module 102, of FIG. 1. In one example, FIG. 2 may represent a dynamic environment, in which interactions are in process (ongoing), relevant information from detailed data stores may be culled and presented, managers may be given prompts or access to make real-time decisions with that information, monitor one or more relevant calls, and perform interventions to resolve issues.

In operations 202-212, the processor may generate contact center information from a plurality of input systems (e.g. modules 104-114 of FIG. 1) including interaction alerts 202 (e.g. long calls, assistance requests), interaction status 204 (e.g. interaction established, duration and topics), agent status 206 (e.g. on a call, requesting assistance, out-of-office), customer information 208 (e.g. customer name, customer priority level), process information 210 (e.g. process name, status and duration), and process alerts 212 (e.g. regulatory compliance alerts, fraud alerts). The processor may compile, integrate and process this disparate contact center information for display via a single user interface.

In operations 214, the processor may send the processed contact center information to a mobile client (e.g. mobile device 116 of FIG. 1), e.g. where it may be viewed by a user on a user interface.

In operations 216, the processor may provide the user interface with information, e.g. to be navigated by the user on the mobile client, for displaying an ordered sequence or hierarchical structure of pages or content. The user interface may initially display an overview page, followed by an interaction page, followed by an agent page and/or a customer page, followed by an intervention page, and optionally followed by an agent training page.

In operations 218, the processor may provide the user interface with interactions to be played in real-time, e.g., call recordings for the user to listen in.

In operations 220, the processor may provide the user interface with past interactions to be played off-line. The past interactions may be selected by the user e.g., to gain an understanding of the needs of the customer or understand past problems or resolutions provided by the current or other agents.

In operations 222, the processor may provide the user interface with a textual interaction record, for example, of a chat, email, SMS message or other textual communication, between the customer and agent. The textual interaction may be displayed via the user interface in real-time or off-line.

In operations 224, the processor may provide the user interface with performance statistics to be displayed via the user interface, for example, for a single agent currently on the call, all agents that have interacted with the customer within a past predetermined period of time, or a predetermined or selected group of agents, e.g., in the agent's or user's department, under the user's supervision, or currently available or on-line agents.

In operations 226, the processor may connect the user to the agent and/or customer to intervene in the interaction, for example, in response to the user's selection to intervene via the intervention page, an agent requesting intervention, or automatically upon detection of a flag or automated alert.

In operations 228, the processor may schedule a training session (e.g. via coach scheduling modules 108 of FIG. 1) in response to an agent or user's training request, or automatically if a flag or alert is raised during the interaction or if the agent does not successfully progress or complete the interaction within a predetermined period of time.

In operations 230-234, the processor may connect a user to the customer or agent to intervene in the interaction. In operation 230, the processor may provide a communication portal via the user interface to connect the user to the agent (e.g. and not the customer) to assist the agent via text communications, such as, chat, email, or SMS messaging. In operation 232, the user may review the mobile interface while traveling to and approaching the user in person. The user-agent interactions of operations 230-232 may be provided separately from and concurrently to the customer-agent interaction. In operation 234, the processor may provide a communication portal in the user interface to connect and join the user into the agent-customer interaction to generate a user-agent-customer interaction. Alternatively, the processor may connect the user directly to the customer without the agent.

Other operations or orders of operations may be used.

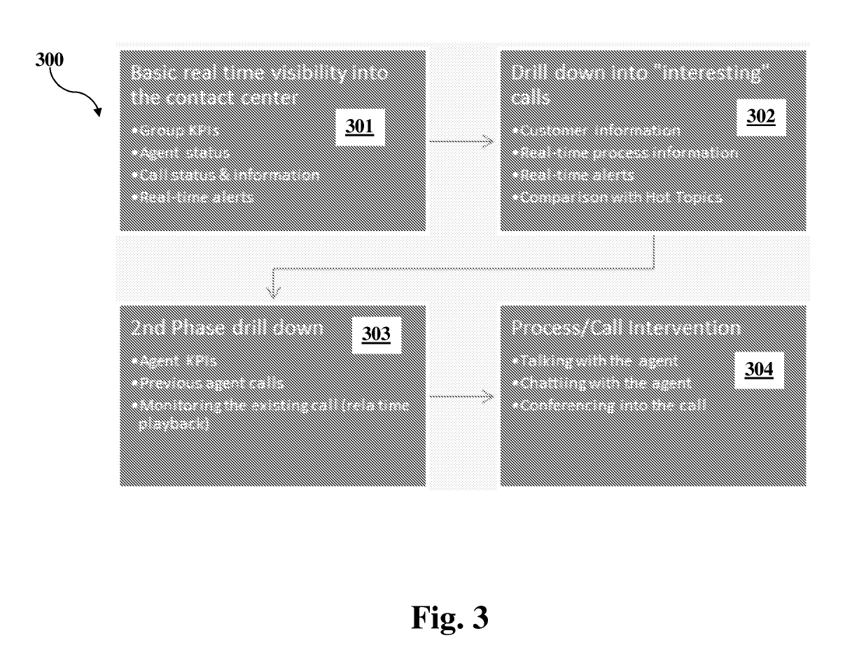

Reference is made to FIG. 3, which schematically illustrates a method for monitoring a contact center in real-time in accordance with an embodiment of the invention. The method of FIG. 2 may be executed by a processor, such as, processor(s) 118 in one or more of modules, such as module 102, of FIG. 1, to generate and provide real-time contact center information, transfer the information to a mobile device, such as, mobile device 116 of FIG. 1, where the information may displayed on a mobile user interface.

In operation 301, the processor may provide the user interface with content describing an overview of the contact center's current status including real-time information, such as, group KPIs, agent status, call status and information and real-time alerts. Based on the information presented in operation 301, a manager may choose to “drill down” or extract additional details related to a selected interaction, alert, KPI or status in operation 302.

In operation 302, in response to said selection, the processor may provide the user interface with additional information and may identify critical information relevant to the specific customer, interaction, alert or topic.

In operation 303, the processor may use the information presented in operation 302 to perform analysis, make comparisons or monitor an existing call.

In operation 304, the processor may connect the user to the customer and/or agent to perform interventions, for example, joining a current call, for online/real-time resolution of an issue after having been informed of the relevant background information in operations 301-303 to assist in resolution.

Other operations or orders of operations may be used.

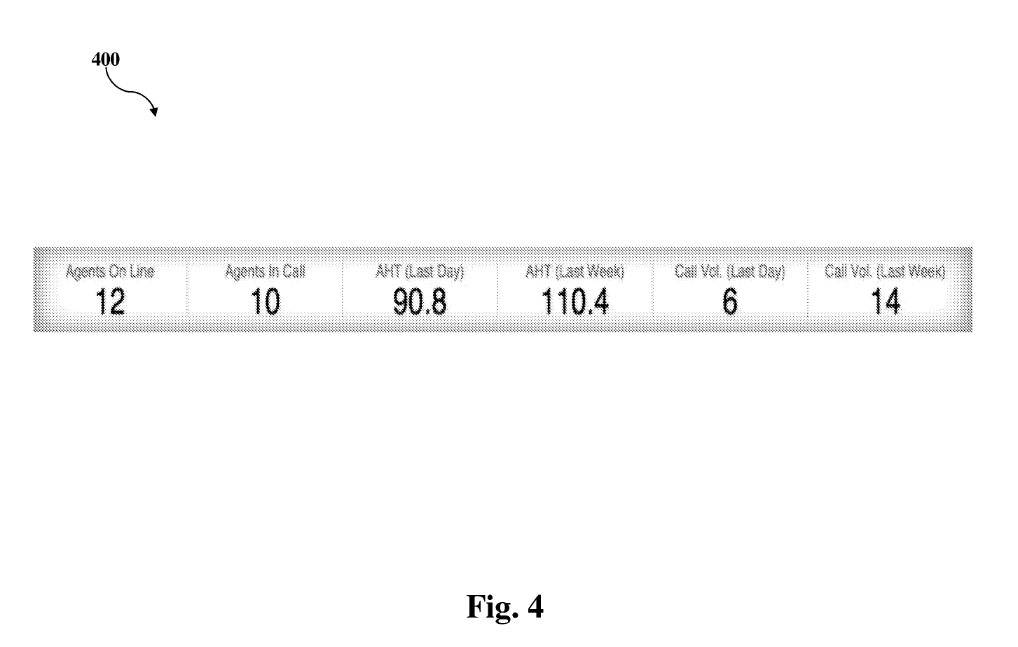

Reference is made to FIG. 4, which schematically illustrates a user interface 400 displaying agent performance statistics for agents in a contact center in accordance with an embodiment of the invention. The agent performance statistics user interface 400 may be displayed, for example, as a toolbar at the top of the overview user interface 500 shown in FIG. 5A.

User interface 400 may include agent summary information and performance statistics, such as, a number of agents on-line, a number of agents in a call, an average handling time (AHT) over a predetermined period(s) of time, such as over the past day and/or week, and a call volume over a predetermined period(s) of time, such as over the past day and/or week. The numbers for the AHT and call volume in user interface 400 may represent average AHT values for the entire team of agents under the manager's supervision. The performance statistics for individual agents may be available to the manager when selecting or drilling down into the user interface 400 fields, for example, providing additional information for each agent, e.g., as shown in FIG. 7A. User interface 400 may include KPI information such as an average KPI for all agents, e.g., under a manager's supervision.

Reference is made to FIG. 5A, which schematically illustrates a user interface 500 displaying an overview page for monitoring a contact center in accordance with an embodiment of the invention and FIGS. 5B-5E, which provide keys defining icons and terminology used in user interface 500 in accordance with an embodiment of the invention.

User interface 500 displays overview information for a plurality of agents in a contact center, department or team. Information associated with each agent may be represented in a tile, window, or other graphical icon, for which color, shading or icons may indicate interaction duration, and which may list the real-time interaction duration, the type or priority level of customer in the interaction, and alerts critical to the management of the center (e.g. possible fraudulent caller, critical topics automatically discerned, agent-initiated request for assistance, etc.).

In some embodiments, the background color, shading or pattern of each tile indicates the status of the represented agent, for example, as follows:
Gray: The agent is either not in or is not currently on a call.
White: The agent is on a call that has not yet become a long call.
Blue: The agent is on a call the duration of which has exceeded a predetermined threshold indicating that the call has become too long.

FIG. 5B shows various icons available for display in the main tiles, which may describe the agent's situation or status, for example, as follows:
the agent is not present.
the agent is not on a call.
the agent is on a call.
the agent needs assistance.

FIG. 5C shows the various agent summary information and performance statistics that may be displayed in user interface 400 of FIG. 4 or, for example, at the top of the overview user interface 500 of FIG. 5A, for example, including:
Agents online: The number of agents online in a contact center, department, team or under a manager's supervision.
Agents on call: The number of agents on a call at that time.
AHT (Last Day): The average handling time per call for today, e.g., in seconds.
AHT (Last Week): The average handling time per call since the beginning of the week, e.g., in seconds.
Call Volume (Last Day): The call volume for all agents per day.
Call Volume (Last Week): The call volume for all agents since the beginning of the week.

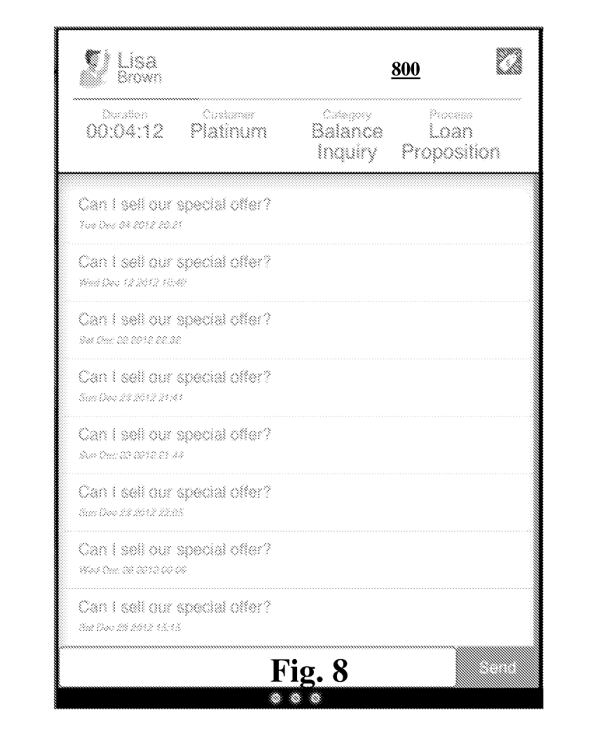

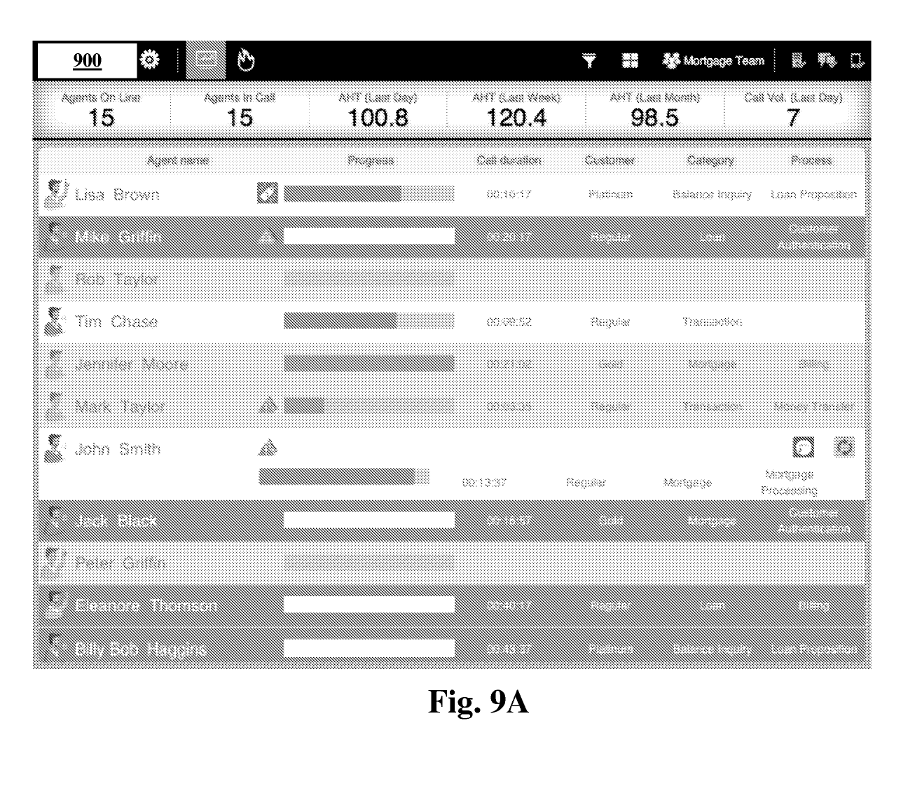

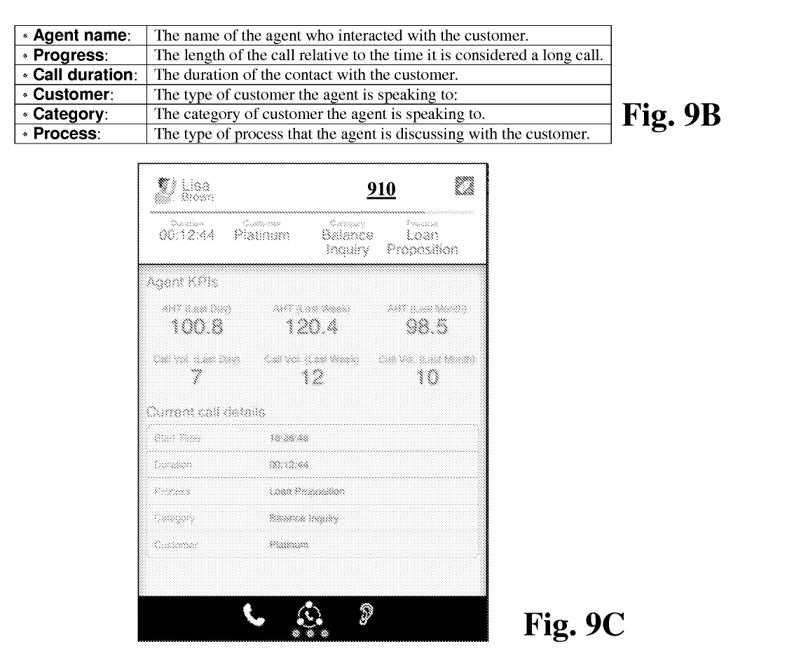

FIG. 5D shows icons used in user interface 500, for example, including:
Settings: Defines the login and language settings.
Monitor: Show the main desktop.
Hot Topics: Shows a graphical representation of interaction topics flagged as high-priority.
Filter: Sets filters for displaying agent information.
List View: Toggles to list view (FIG. 9A) from tile view (FIG. 5A).
Tile View: Toggles to tile view (FIG. 5A) from list view (FIG. 9A).
Groups: Enables a user to select groups of agent tiles to display. The name of the selected group is displayed next to the icon.
System Server: Indicates that a mobile device (e.g. mobile device 116 of FIG. 1) displaying user interface 500 is connected to the system server (e.g. module 102 of FIG. 1).
Message: Indicates that the mobile device is connected to a speech-to-text converted and voice recognition system for controlling user interface and mobile device operations via voice commands.
Softphone: Indicates that the mobile device is connected to a telephony system.

FIG. 5E shows information provided for an agent in each tile, which includes, for example, the following:
Name: The name of the agent.
Alert: Icons indicating that there is an alert(s) associated with the agent's interaction.
Call progress bar: Indication of the length of the call relative to the time it is considered a long call. The amount of time that constitutes a long call may be configurable, e.g., automatically by module 102, inversely proportional to interaction/call volume and proportional to customer priority, hot topics, returning customer status and/or other system parameters.
Duration: The length of the agent-customer interaction (including or excluding transfers from other agents in the contact center).
Customer: The type of customer with which the agent is interacting.
Category: The category of customer with which the agent is interacting.
Process: The type of process that the agent is discussing with the customer.

The display, icons, tile or list representations, or any of the features described above in reference to FIGS. 5A-5E may be customized and saved in personal settings for each individual user or manager. For example, managers may select different tiles for the unique group of agents, slide windows to different positions, select statistics to be viewed in the summary information display, and select the sources of information to be displayed, for example, integrating different CMR systems, for the user's unique group of agents, layers,

Other icons, terminology or information may be used.

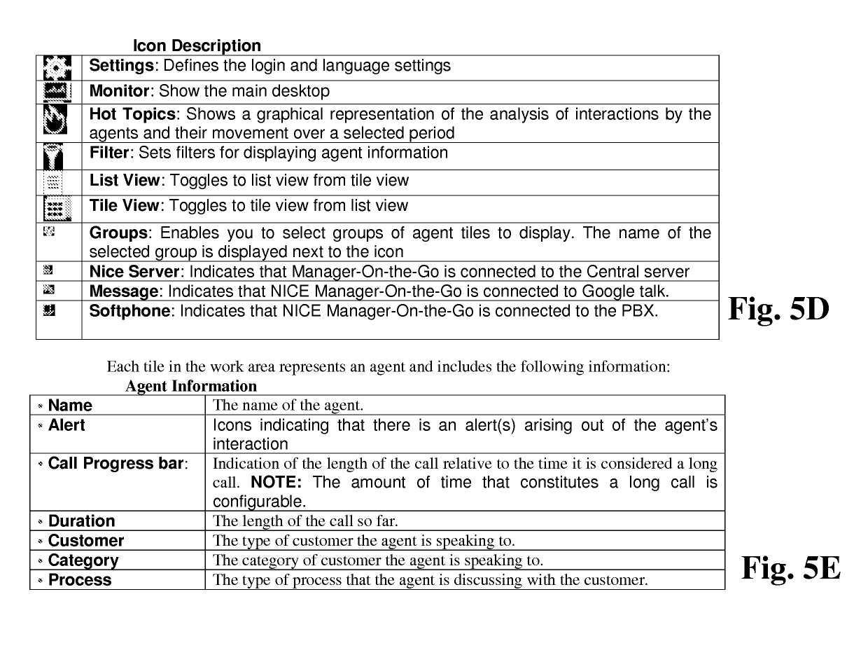

Reference is made to FIG. 6, which schematically illustrates an alert 600 to be displayed on a user interface (e.g. 400 or 500) and a key of icon alert categories that may trigger alert 600 to be display in accordance with an embodiment of the invention.

Alert categories may include, for example:
Authentication.
Chum.
Compliance.
Fraud.
Multiple alerts.
Non-adherence.
Repeat.
Sale or potential sale, for example, to a high-level customer or for a high-profile product or service.

Each of the above alerts may have one of the following alert levels, for example, each indicated by a color, indicating the urgency or degree of the alert:
High: Red
Medium: Yellow
Low: White

Reference is made to FIG. 7A, which schematically illustrates a user interface 700 displaying an interaction page for monitoring an interaction, for example, selected from the overview page of user interface 500, in accordance with an embodiment of the invention. FIG. 7A shows a “drill-down” or expanded view of details for one agent-customer interaction. The interaction details view shown in FIG. 7A may be displayed in response to a manager request, for example, by tapping or selecting the agent's tile on the overview page display in FIG. 5A.

FIG. 7B describes information displayed in the interaction page of FIG. 7A, which may include, for example:
Agent KPIs: KPIs are shown for the selected agent.
AHT (Last Day): The agent's average handling time per interaction for the current day, for example, in seconds.
AHT (Last Week): The agent's average handling time per interaction since the beginning of this week.
AHT (Last Month): The agent's average handling time per interaction since the beginning of this month.
Call Volume (Last Day): The agent's interaction volume for the current day.
Call Volume (Last Week): The agent's interaction volume since the beginning of this week.
Call Volume (Last Month): The agent's interaction volume since the beginning of this month
Current Interaction details: The following current interaction details are shown.
Start Time: The time the interaction started.
Duration: The duration of the interaction so far.
Process: The type of process that the agent is discussing with the customer.
Category: The category or importance level of the customer with which the agent is interacting.

Once equipped with the above information, the system may provide the manager, with the following options for intervening in an interaction between the agent and customer.
Call the agent, e.g., on a separate call than the agent-customer interaction.
Chat with the agent, e.g., on a separate chat than the agent-customer interaction.
Establish a conference call with the agent and the customer.
Intercede and listen to the current interaction between the agent and the customer.

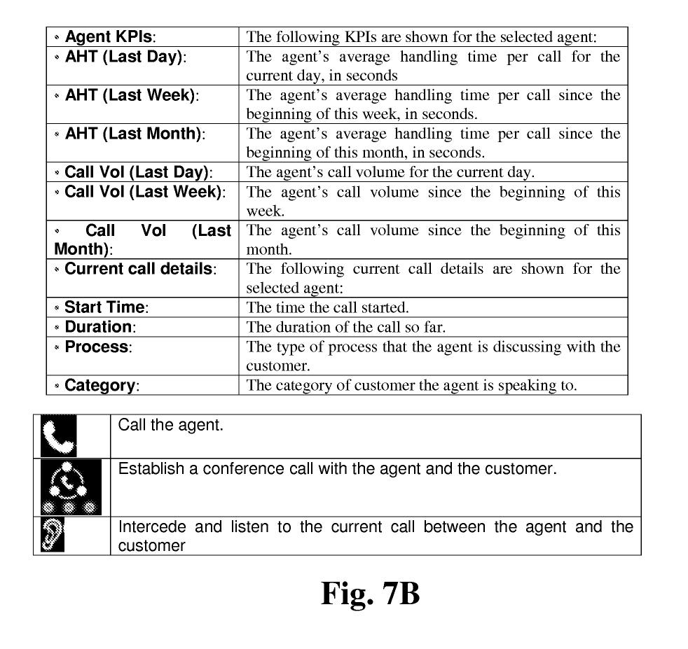

Reference is made to FIG. 8, which schematically illustrates a user interface 800 providing a chat screen for a user to communicate with one of the agents in a contact center in accordance with an embodiment of the invention. The manager may access an agent's chat screen from the overview page displayed in FIG. 5A or the agent's interaction page displayed in FIG. 7A. The chat screen may show the agent's chat history, e.g., with the manager, other personnel or agents, or with customers.

Reference is made to FIG. 9A, which schematically illustrates a user interface 900 for monitoring the performance of agents in a list view in accordance with an embodiment of the invention. From the time view of FIG. 5A, a tap of the list icon may display the overview page in the list view of FIG. 9A, in which information associated with each interaction or agent is displayed in a unique row.

List user interface 900 may display the same information as tile user interface 500 and/or the following additional agent details shown in FIG. 9B:
Progress: The length of the call relative to the time considered to be a long call.
Category: The category of transaction or issue the agent is resolving.
Process: The type of process that the agent is discussing with the customer.

Reference is made to FIG. 9C, which schematically illustrates a user interface 910 providing a current interaction details sub-page for a selected interaction or agent in accordance with an embodiment of the invention. The current call details sub-page in FIG. 9C may be displayed in response to a user tapping or selecting a row or line of the display in FIG. 9A associated with that interaction or agent and may provide a detailed view of current interaction information for the selected interaction or agent.

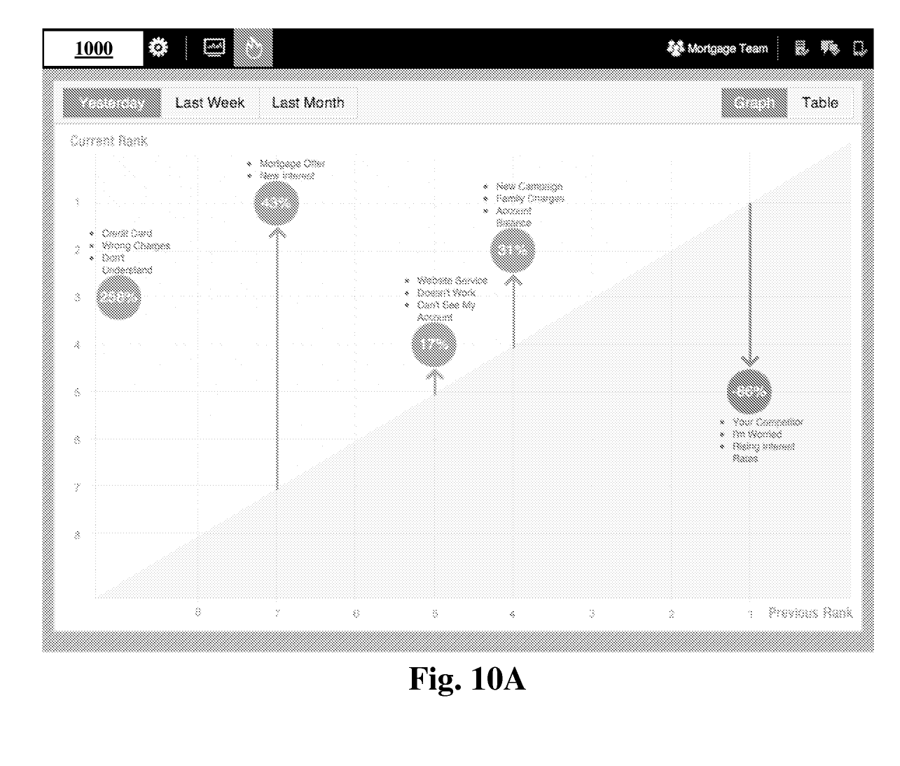

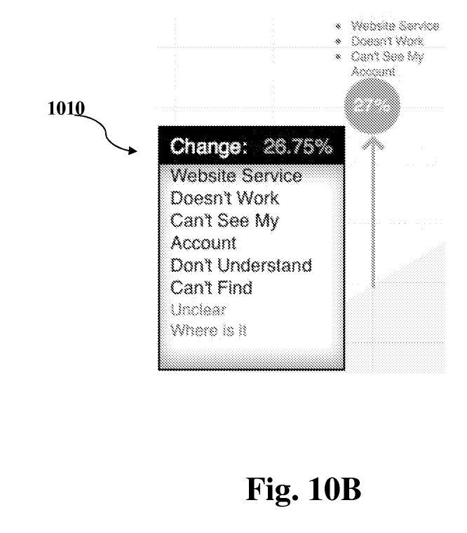

Reference is made to FIG. 10A, which schematically illustrates a graph view 1000 showing popular topics of customer interactions, for example, referred to as “hot topics,” in accordance with an embodiment of the invention. Topics may be automatically detected in voice interactions for example using automated voice analysis software or in text interactions for example using automated text analysis software.

A change in the occurrence frequency of each topic may be represented by a percentage e.g. shown in a cluster bubble in graph view 1000. The change may be measured over a selected predetermined period of time, such as, a day, week or month. A plurality of (e.g. up to three) most significant key words may be shown for each topic displayed in a cluster bubble. Tapping or otherwise selecting a bubble may cause the user interface to display all the significant key words associated with the topic, as shown in user interface 1010 of FIG. 10B.

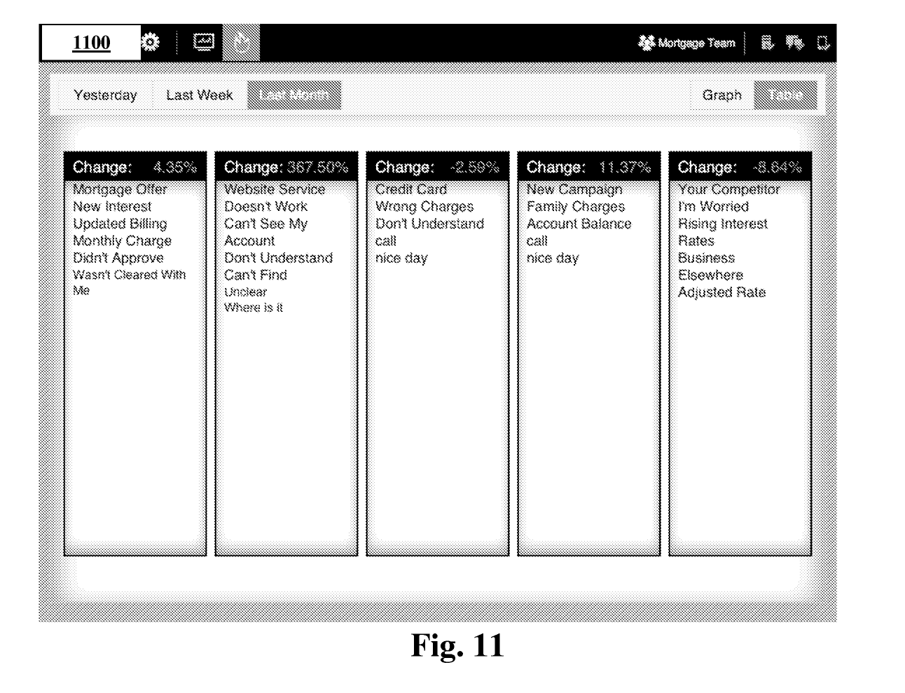

Reference is made to FIG. 11, which schematically illustrates a table view 1100 of the plurality of topics of FIG. 10A, in accordance with an embodiment of the invention.

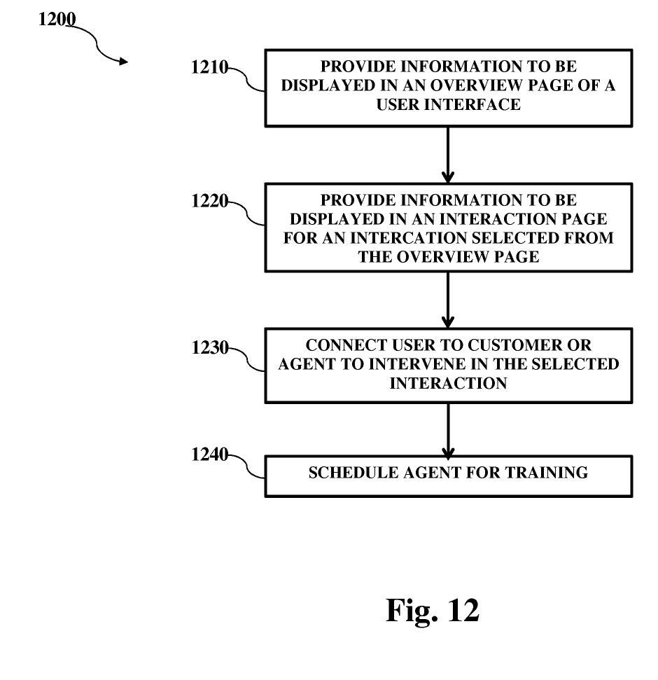

Reference is made to FIG. 12, which is a flowchart of a method for monitoring a contact center in real-time in accordance with an embodiment of the invention. The method may be executed by a processor, such as, processor(s) 118 of module 102 or another module in FIG. 1.

In operation 1210, the processor may provide information (e.g. to mobile device 116 of FIG. 1) to be displayed in an overview page of a user interface (e.g. overview page user interface 500 of FIG. 5A). The overview page may provide information associated with a plurality of agents in a contact center. The information may include, for example, real-time status information indicating that one or more of the plurality of agents are currently involved in customer interactions and indicating progress of the interactions, such as, a ratio of the interaction duration to a standard or threshold duration of time.

In operation 1220, the processor may provide information to be displayed in an interaction page of the user interface (e.g. interaction page user interface 700 of FIG. 7A) for a selected one of the customer interactions. The interaction page may automatically summarize the current customer-agent interaction in real-time, for example, including a textual report paraphrasing or summarizing the topic, issue and solution being used in the current interaction.

In operation 1230, the processor may connect a user to the customer or agent to intervene in the current selected interaction. The processor may connect the user to the agent alone via text communication (e.g. operation 230 in FIG. 2), by telephone, or to both the customer and agent by joining the call (e.g. operation 234 in FIG. 2).

In operation 1240, the processor may provide and/or update the agent's training schedule (e.g. operation 228 in FIG. 2), for example, according to a request from the user or agent or automatically in response to an alert associated with the interaction, if the agent progress is below a threshold, or if the agent receives negative feedback from the customer (e.g. via module 112 of FIG. 1).

Other operations or orders of operations may be used.

The following abbreviations may be used according to embodiments of the invention:

Manager-on-the-Go—A user interface, workflow or system operating according to embodiments of the invention.

KPI—Key Performance Indicators—Call center metrics.

CPA—Call Part Analysis—Automated intelligent analysis of calls that discern key trends in the call.

CTA—Call Topic Analysis.

CFA—Call Flow Analytics.

As used herein, an interaction may refer to any communication between two user devices, e.g., typically a customer device and an agent device, or when a manager intervenes, between a manager device and agent device or among a manager device, agent device and customer device. An interaction may use any form of communication between devices, such as, computers (for web or Internet connections), telephones (for telephone or radio network connections), or SMS messaging or text enabled devices (for messaging network connections), etc.

It may be appreciated that “real-time” may refer to instantly, at a small time delay of, for example, between 0.01 and 10 seconds, during, concurrently, or substantially at the same time as. For example, receiving a report, statistics such as KPIs or other information about a customer-agent interaction in real-time may include receiving that information while the interaction is ongoing. It may be appreciated that although embodiments of the invention are described to operate in real-time, such embodiments may also operate off-line, for example, at a later time.

It may be appreciated that although certain devices and functionality are assigned to “managers,” “customers” and “agents” in a contact center or call center environment, such functionality may be implemented by any users in any environment. Users may include two or more live users, two or more automated user(s) or a combination of live user(s) and automated user(s).

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for monitoring a contact center in real-time, the method comprising:
providing, to a contact center manager, information to be displayed in an overview page of a user interface on a mobile device associated with a plurality of agents in a contact center including real-time status information on call interactions between a customer and at least one of the plurality of agents, the information indicating that one or more of the plurality of agents are currently involved in call interactions and indicating progress of the call interactions based on a measure of duration of the call interactions,
providing information to be displayed in an interaction page of the user interface for a selected one of the call interactions automatically summarizing the customer interaction in real-time; and
connecting the contact center manager to the customer or agent to intervene in the selected call interaction.

2. The method of claim 1 comprising displaying an agent page for the agent involved in the selected interaction, the agent page providing real-time information defining the agent's performance in the current interaction and the agent's cumulative performance averaged over historical data associated with the agent's past interactions.

3. The method of claim 1 comprising displaying a customer page for the customer involved in the selected interaction, the customer page providing real-time and historical data associated with the customer.

4. The method of claim 1 comprising displaying real-time automated alerts to prompt the contact center manager to intervene in the selected interaction.

5. The method of claim 4, wherein the automated alerts indicate problem interactions associated with negative customer feedback, interactions that have been transferred greater than a predetermined number of times, interactions that have durations greater than a predetermined amount of time, interactions identified as potentially fraudulent, or high priority interactions associated with one or more predefined topics of interest, products of interest, or high priority customers.

6. The method of claim 1, wherein the contact center manager is connected to the agent in a manager-agent interaction separately from and concurrently to the customer-agent interaction.

7. The method of claim 1, wherein the contact center manager is connected directly to the customer-agent interaction.

8. The method of claim 1, wherein the pages are displayed in an ordered navigation sequence comprising the overview page, followed by an interaction page, followed by an agent page or a customer page, followed by an intervention page, and optionally followed by an agent training page.

9. The method of claim 1 comprising receiving information from a plurality of separate modules including an interaction management module recording interactions in real-time and providing interaction playback, an analysis module providing the agent status information, the interaction progress information, the interaction summary information and automated alerts, and a customer information module providing real-time customer interaction summary information and historical customer interaction data.

10. The method of claim 1, wherein the pages are displayed on a mobile platform allowing the contact center manager to view the pages while mobile.

11. A system for monitoring a contact center in real-time, the system comprising:
a mobile device including:
a processor to provide a user interface to a contact center manager including a first page showing a plurality of graphical icons including information associated with a plurality of respective contact center agents, each graphical icon indicating a current call with a customer being executed by the associated agent and a progress of the call based on a measure of duration of the call in real-time, and a second page for one of the plurality of contact center agents associated with a graphical icon on the first page, the second page showing statistics indicating the performance of the associated agent in successfully completing the current call; and
a display to display the user interface.

12. The system of claim 11, wherein the first page includes tiles associated with the plurality of contact center agents that have an active working status.

13. The system of claim 11, wherein the first page includes tiles associated with the plurality of contact center agents that are working in a particular physical location.

14. The system of claim 11, wherein the first page includes tiles associated with the plurality of contact center agents that are in a manager's department.

15. A system for monitoring a contact center in real-time, the system comprising:
a mobile device including:
a processor to provide, to a contact center manager, an overview page and an interaction page, the overview providing information associated with a plurality of agents in a contact center including real-time status information on call interactions between a customer and at least one of the plurality of agents, the information indicating that one or more of the plurality of agents are currently involved in call interactions with a customer and indicating progress of the call interactions based on a measure of duration of the call interactions, the interaction page associated with a selected one of the call interactions providing computer-generated information summarizing the call interaction in real-time;
a display to display the overview page and the interaction page; and
a communications device for connecting the contact center manager to the customer or agent to intervene in the selected call interaction.

16. The system of claim 15, wherein the processor receives the data displayed on the overview page and the interaction page from a plurality of separate modules including an interaction management module recording interactions in real-time and providing interaction playback, an analysis module providing the agent status information, the interaction progress information, the interaction summary information and automated alerts, and a customer information module providing real-time customer interaction summary information and historical customer interaction data.

17. The system of claim 15, wherein the contact center manager is connected to the agent in a manager-agent interaction separately from and concurrently to the customer-agent interaction.

18. The system of claim 15, wherein the contact center manager is connected directly to the customer-agent interaction.

19. The system of claim 15, wherein the processor provides the pages to be displayed in an ordered navigation sequence comprising the overview page, followed by an interaction page, followed by an agent page or a customer page, followed by an intervention page, and optionally followed by an agent training page.

20. The system of claim 15, wherein the user-interface displays a plurality of graphical icon associated with each interaction, wherein the user-interface is a touch-operated device, providing one-touch navigation upon selecting an interaction graphical icon from the overview page to the interaction page.

21. The system of claim 1, wherein the progress of the call interactions is a measure of duration of the call interactions relative to a predetermined threshold duration.
